(19) United States
(12) Patent Application Publication
(10) Pub. No.: US 2026/0343633 A1
(43) Pub. Date: Oct. 29, 2026

(54) THROUGHPUT-BASED UPLINK (UL) S-CELL SELECTION

(71) Applicant: T-Mobile USA, Inc., Bellevue, WA (US)

(72) Inventors: Mochamad MIRZA, Bothell, WA (US); Nishant PATEL, Irvine, CA (US)

(21) Appl. No.: 19/190,488

(22) Filed: Apr. 25, 2025

(51) Int. Cl. H04W 76/10; H04W 72/232

(52) U.S. Cl. CPC H04W 76/10; H04W 72/232

(57) ABSTRACT

Disclosed solutions provide for throughput-based uplink (UL) secondary cell (s-cell) selection for carrier aggregation (CA). When a user equipment (UE) is using a first UL CA configuration having a primary cell (p-cell) and a first s-cell, the wireless network periodically estimates the expected throughput for the UE for each available s-cell, such as the plurality of s-cells used for the downlink (DL) CA. This may include assessment of both radio signal quality and scheduling availability. When another s-cell, other than the currently-used s-cell has greater expected throughput, the network instructs the UE to use the other s-cell. Examples may use downlink control information (DCI) to instruct the s-cell change, avoiding the disruption caused by a radio resource control (RRC) reconfiguration. DCI is also used to schedule data transmission on the new s-cell. This improves UL throughput, not only by selecting a superior throughput s-cell, but also by minimizing traffic disruptions.

### BACKGROUND

Carrier aggregation (CA) in cellular networks is the use of multiple cells simultaneously, and may be used on both downlink (DL) and uplink (UL) directions. Currently, DL CA may use up to six component carriers (CCs), with one designated as the primary cell (p-cell) and the other five designated as secondary cells (s-cells). Due to the cost and complexity of radio frequency (RF) transmitters, along with size, weight, and battery demand constraints in user equipment (UEs), UL CA uses only two CCs-one p-cell and one s-cell. The UL CA is a subset of DL CA, such that the p-cell is the same for both UL and DL, and the UL CA s-cell is one of the DL CA s-cells.

Selection of the UL s-cell is based on loading or nominal channel bandwidth (i.e., the channel's inherent potential bandwidth in good signal conditions). S-cells remain in place until reaching a handover (HO) condition, and is accomplished using a radio resource control (RRC) reconfiguration message. Unfortunately, RRC reconfigurations are disruptive to data throughput, and the current s-cell selection criteria may be sub-optimal in some scenarios.

### SUMMARY

The following summary is provided to illustrate examples disclosed herein, but is not meant to limit all examples to any particular configuration or sequence of operations.

Solutions are disclosed that provide for throughput-based uplink (UL) secondary cell (s-cell) selection. Examples instruct, by a wireless network, a user equipment (UE) to use a first UL carrier aggregation (CA) configuration having a primary cell (p-cell) and a first s-cell; estimate a throughput for the UE for each s-cell of a plurality of s-cells, wherein the plurality of s-cells comprises the first s-cell; select a second s-cell within the plurality of s-cells, for use by the UE, based on at least the second s-cell having a higher estimated throughput for the UE than the first s-cell; and without changing the p-cell, instruct, by the wireless network, the UE to use the second s-cell in a second UL CA configuration.

### BRIEF DESCRIPTION OF THE DRAWINGS

The disclosed examples are described below with reference to the accompanying drawing figures listed below, wherein:

FIG. 1 illustrates an exemplary architecture that advantageously provide for throughput-based uplink (UL) secondary cell (s-cell) selection;

FIG. 2 illustrates different carrier aggregation (CA) configurations, as may be used in examples of the architecture of FIG. 1;

FIG. 3 illustrates an exemplary secondary cell (s-cell) selection logic that may be used in examples of the architecture of FIG. 1;

FIG. 4 illustrates exemplary air interface messaging that may be used in examples of the architecture of FIG. 1;

FIGS. 5 and 6 illustrate flowcharts of exemplary operations associated with the architecture of FIG. 1; and

FIG. 7 illustrates a block diagram of a computing device suitable for implementing various aspects of the disclosure.

Corresponding reference characters indicate corresponding parts throughout the drawings. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

Disclosed solutions provide for throughput-based uplink (UL) secondary cell (s-cell) selection for carrier aggregation (CA). When a user equipment (UE) is using a first UL CA configuration having a primary cell (p-cell) and a first s-cell, the wireless network estimates (on a repeating basis, e.g., periodically) the expected throughput for the UE for each available s-cell, such as the plurality of s-cells used for the downlink (DL) CA. This may include assessment of both radio signal quality and scheduling availability. When another s-cell, other than the currently-used s-cell has greater expected throughput, the network instructs the UE to use the other s-cell. Examples may use downlink control information (DCI) to instruct the s-cell change, avoiding the disruption caused by a radio resource control (RRC) reconfiguration. DCI is also used to schedule data transmission on the new s-cell. This improves UL throughput, not only by selecting a superior throughput s-cell, but also by minimizing traffic disruptions.

Aspects of the disclosure improve data-carrying capacity of wireless networks, for example in the UL direction, by optimizing the UL s-cell selection based on expected throughput, and minimizing traffic disruptions by avoiding the use of RRC reconfigurations when changing only the s-cell. These advantageous results are accomplished, at least in part, by selecting a second s-cell within a plurality of s-cells, for use by the UE, based on at least the second s-cell having a higher estimated throughput for the UE than the current s-cell and, without changing the p-cell, instructing the UE to use the second s-cell.

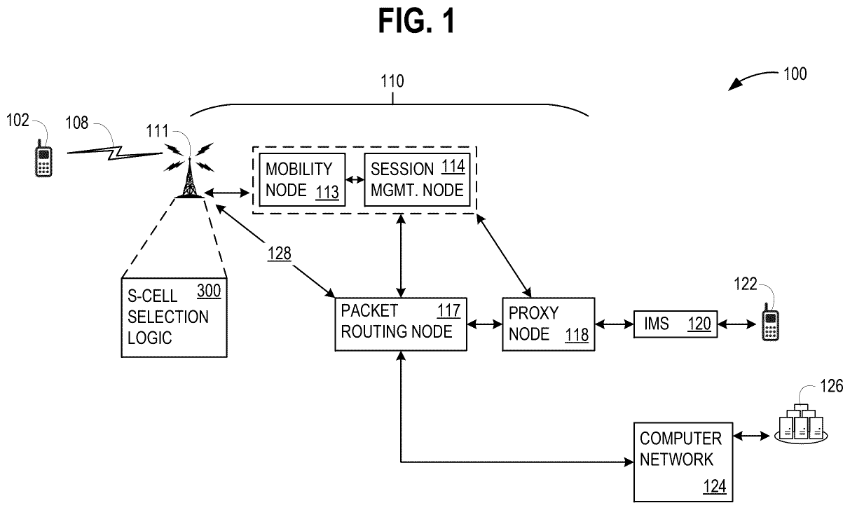

With reference now to the figures, FIG. 1 illustrates an exemplary architecture 100 that advantageously provide for throughput-based UL s-cell selection. A wireless network 110 is illustrated that is serving a UE 102. UE 102 may be an enhanced mobile broadband (eMBB) or cellphone, a fixed wireless access (FWA), an internet of things (IoT) device, a machine-to-machine (M2M) communication device, a personal computer (PC, e.g., desktop, notebook, tablet, etc.) with a cellular modem, or another telecommunication device capable of using a wireless network. In the scene depicted in FIG. 1, UE 102 is using wireless network 110 for a packet data session to reach a network resource 126 (e.g., a website) across an external packet data computer network 124 (e.g., the internet). In some scenarios, UE 102 may use wireless network 110 for a phone call with another UE 122. Wireless network 110 may be a cellular network such as a fifth generation (5G) network, a fourth generation (4G) network, or another cellular generation network. In some contexts, 5G is also referred to as new radio (NR), and standalone 5G, which is a full 5G implementation that does not rely on 4G technology for some functionality, may be referred to SA NR.

UE 102 uses an air interface 108 to communicate with a base station 111 of wireless network 110, such that base station 111 is the serving base station for UE 102 (providing the serving cell). In some scenarios, base station 111 may be referred to as a radio access network (RAN). Wireless network 110 has a mobility node 113, a session management node 114, and other components (not shown). Wireless network 110 also has a packet routing node 117 and a proxy node 118. Mobility node 113 and session management node 114 are within a control plane of wireless network 110, and packet routing node 117 is within a data plane (a.k.a. user plane) of wireless network 110.

Base station 111 is in communication with mobility node 113 and packet routing node 117. Mobility node 113 is in communication with session management node 114, which is in communication with packet routing node 117, and proxy node 118. Packet routing node 117 is in communication with proxy node 118 and computer network 124. In some 5G examples, base station 111 comprises a gNodeB (gNB), mobility node 113 comprises an access mobility function (AMF), session management node 114 comprises a session management function (SMF), and packet routing node 117 comprises a user plane function (UPF). In some 4G examples, base station 111 comprises an eNodeB (eNB), mobility node 113 comprises a mobility management entity (MME), session management node 114 comprises a system architecture evolution gateway (SAEGW) control plane (SAEGW-C), and packet routing node 117 comprises an SAEGW-user plane (SAEGW-U). In some examples, proxy node 118 comprises a proxy call session control function (P-CSCF) in both 4G and 5G.

Proxy node 118 is in communication with an internet protocol (IP) multimedia system (IMS) 120, which uses an access gateway (IMS-AGW) in order to provide connectivity to other wireless (cellular) networks, such as for a call with a UE 122 or a public switched telephone system (PSTN, also known as plain old telephone system, POTS). In some examples, proxy node 118 may be considered to be within IMS 120. UE 102 reaches network resource 126 using computer network 124 (or IMS 120, in some examples). Data packets of data traffic 128 to/from UE 102 pass through at least base station 111 and packet routing node 117 on their way from/to computer network 124 or IMS 120 (via proxy node 118).

In some examples, wireless network 110 has multiple ones of each of the components illustrated, in addition to other components and other connectivity among the illustrated components. In some examples, wireless network 110 has components of multiple cellular technologies operating in parallel in order to provide service to UEs of different cellular generations. For example, wireless network 110 may use both a gNB and an eNB co-located at a common cell site. In some examples, multiple cells may be co-located at a common cell site, and may be a mix of 5G and 4G.

As illustrated in further detail in the remaining figures, an s-cell selection logic 300 determines (e.g., estimates) expected throughput for UE 102 for multiple s-cells upon various trigger events (e.g., periodic timer lapses), when UE 102 is using CA. If a different s-cell, other than the one that UE 102 is currently using, is able to provide higher throughput, UE 102 is moved to that s-cell without changing the p-cell. Although s-cell selection logic 300 is illustrated as being located within base station 111, in some examples, s-cell selection logic 300 may be located elsewhere within wireless network 110, for example within mobility node 113, and/or distributed among multiple locations.

Although FIG. 1 and some of the following figures are described using an example of a cellular network, it should be understood that the teachings herein are applicable to other types of wireless networks. To benefit from the teachings herein, another wireless network, other than a cellular network, should provide an equivalent to CA, and instruct UEs on handovers (HOs). With such features, another type of wireless network, other than a cellular network, may also benefit from the disclosure herein.

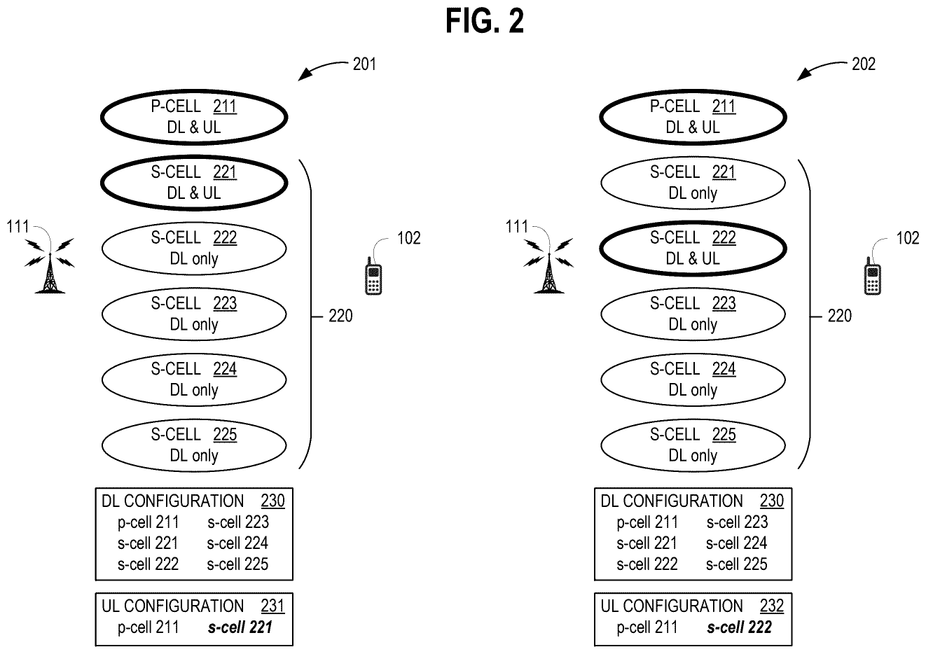

FIG. 2 illustrates different CA configurations, as may be used for UE 102 in examples of architecture 100. Base station 111 of wireless network 110 instructs UE 102 to use an initial CA configuration 201 that has a DL CA configuration 230 and an UL CA configuration 231. DL CA configuration 230 has a p-cell 211 and a plurality of s-cells 220 that includes an s-cell 221, an s-cell 222, an s-cell 223, an s-cell 224, and an s-cell 225. UL CA configuration 231 has the same p-cell 211 and also uses s-cell 221. Thus, p-cell 211 and s-cell are used for both UL and DL, whereas s-cells 222-225 are used for UL only.

At a later time, as described below, UE 102 changes to using a CA configuration 202 that has the same DL CA configuration 230, but a new UL CA configuration 232. UL CA configuration 232 has p-cell 211, but now uses s-cell 222 in place of s-cell 221. Thus, p-cell 211 and s-cell 222 are used for both UL and DL, whereas s-cell 221 and s-cells 223-225 are used for UL only.

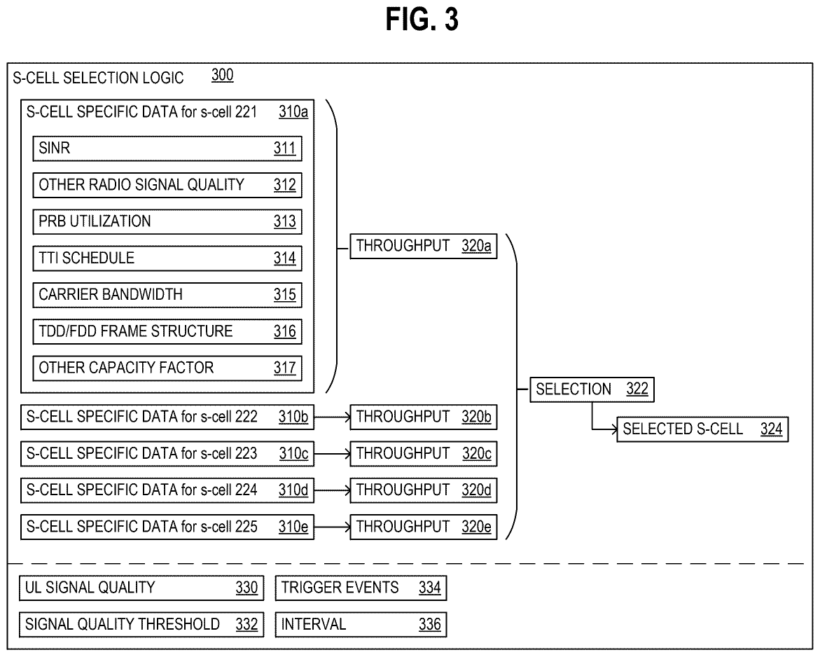

FIG. 3 illustrates further detail for an example of s-cell selection logic 300. S-cell selection logic 300 has s-cell specific data for each s-cell, such as s-cell specific data 310a for s-cell 221, s-cell specific data 310b for s-cell 222, s-cell specific data 310c for s-cell 223, s-cell specific data 310d for s-cell 224, and s-cell specific data 310e for s-cell 225. Each of these data sets has data to predict expected throughput for UE 102 on its corresponding s-cell, using both radio signal quality information and scheduling availability.

Examples of this specific data are shown for s-cell specific data 310a; s-cell specific data 310b-310e are similar. S-cell specific data 310a has (for s-cell 221) a signal-to-interference-plus-noise (SINR) 311, another radio signal quality parameter 312 (e.g., another RF measurement), a physical resource block (PRB) utilization 313, a transmission time interval (TTI) schedule 314, a carrier bandwidth 315, a time division duplexing (TDD) / frequency division duplexing (FDD) frame structure 316, and another capacity factor 317.

An expected throughput is estimated for each candidate s-cell, using radio signal quality and/or scheduling availability. For example, an expected throughput 320a is estimated for s-cell 221 using s-cell specific data 310a; an expected throughput 320b is estimated for s-cell 222 using s-cell specific data 310b; an expected throughput 320c is estimated for s-cell 223 using s-cell specific data 310c; an expected throughput 320d is estimated for s-cell 224 using s-cell specific data 310d; and an expected throughput 320e is estimated for s-cell 225 using s-cell specific data 310e. A selection 322 is performed that identifies (selects) a selected s-cell 324, such as the s-cell having the highest throughput of (expected) throughputs 320a-320e. In an example described in FIGS. 2, 4, and 5, selected s-cell 324 is s-cell 222.

Some examples perform the estimation of s-cell throughputs on some repeating trigger events 334, such as lapses of a timer. In some examples, when the s-cell UL radio signal quality 330, for the currently-selected s-cell (e.g., SINR 311 or other radio signal quality parameter 312) is above a UL signal quality threshold 332, an interval 336 between repeating trigger events 334 is extended. That is, when radio signal quality is good, the s-cell throughput estimation is performed less often, but when radio signal quality is not as good (i.e., below UL signal quality threshold 332) the s-cell throughput estimation is performed more often.

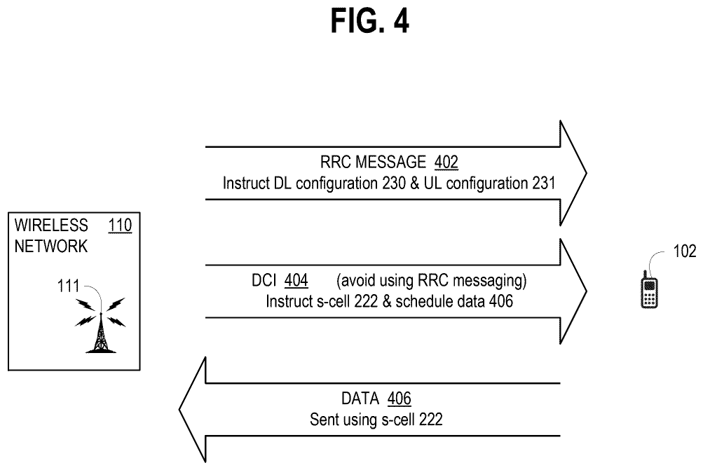

FIG. 4 illustrates exemplary messaging between wireless network 110 and UE 102. Wireless network 110 sends an RRC message 402 to UE 102, such as an RRC reconfiguration message (e.g., RRCConnectionReconfiguration) to instruct UE 102 to use DL CA configuration 230 and UL CA configuration 231.

Later, upon determining that s-cell 222 has higher throughput than s-cell 221, wireless network 110 instructs UE 102 to use s-cell 222 instead of s-cell 221, but uses DCI 404 (which is in the physical downlink control channel, PDCCH) in order to avoid the disruptions (e.g., to p-cell 211) that would be caused by using another RRC message for this change. DCI 404 is also used for scheduling UL data transmissions on s-cell 222. UE 102 then transmits data 406 to wireless network 110 using s-cell 222.

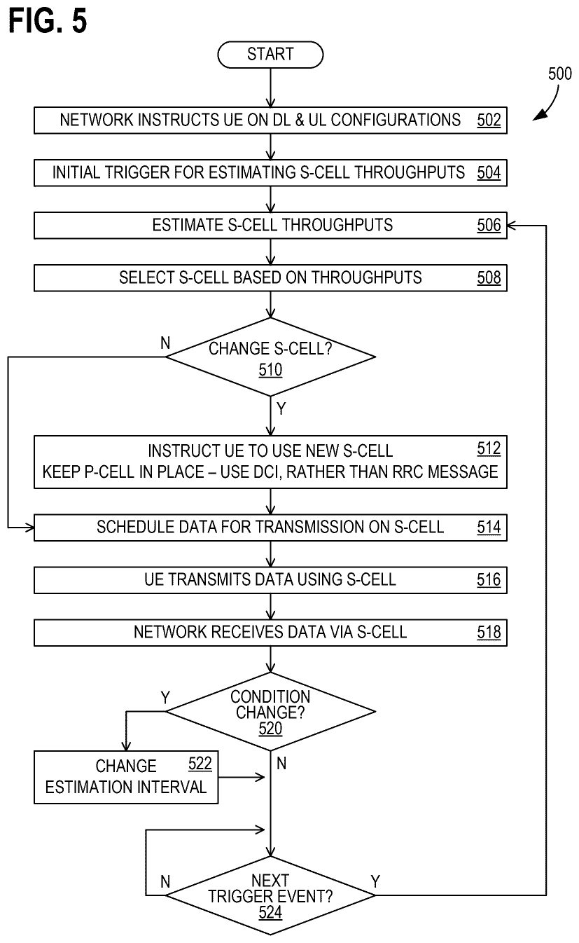

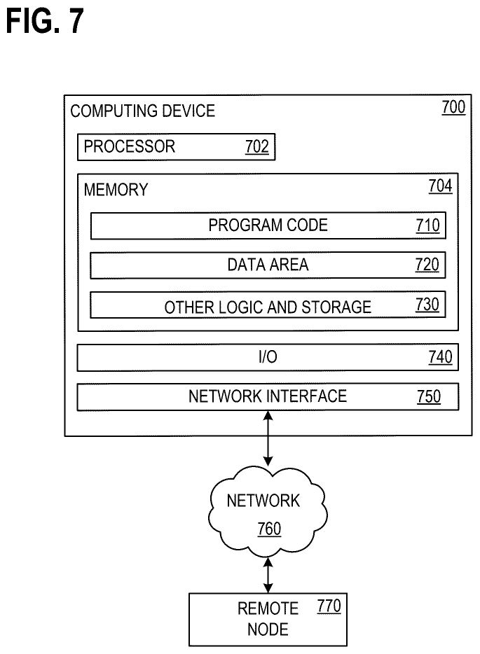

FIG. 5 illustrates a flowchart 500 of exemplary operations associated with examples of architecture 100. In some examples, at least a portion of flowchart 500 may be performed using one or more computing devices 700 of FIG. 7. Flowchart 500 commences with wireless network 110 instructing UE 102 to use DL CA configuration 230, with p-cell 211 and plurality of s-cells 220, by using RRC message 402, in operation 502. Plurality of s-cells 220 comprises s-cell 221 and s-cell 222. Operation 504 is an initial trigger event, such as the lapse of a timer after sending RRC message 402.

In operation 506, s-cell selection logic 300 estimates the throughput for UE 102 for each s-cell of plurality of s-cells 220, such as estimating throughputs 320a-320e. In some examples, estimating the throughput for UE 102 for each s-cell comprises, for each s-cell: determining SINR 311 for the s-cell, determining PRB utilization 313 for the s-cell, determining TTI schedule 314 for the s-cell, determining carrier bandwidth 315 of the s-cell, and/or determining TDD/FDD frame structure 316 for the s-cell. In some examples, the estimated throughput for UE 102 is based on at least both radio signal quality and scheduling availability.

S-cell selection logic 300 selects s-cell 222 for use by UE 102 based on at least s-cell 222 having a higher estimated throughput for UE 102 than s-cell 221, in operation 508. In some examples, s-cell 222 is selected because it has the highest estimated throughput for UE 102 of all s-cells in plurality of s-cells 220. Decision operation 510 determines whether the s-cell selected in operation 508 is the current s-cell or a new s-cell (i.e., the s-cell is being changed). If not, flowchart moves to operation 514, described below. If a new s-cell is selected then, without changing p-cell 211, wireless network 110 instructs UE 102 to use s-cell 222, in operation 512, changing to UL CA configuration 232 (that has s-cell 222 but not s-cell 221). This may be accomplished without using an RRC message, and instead using DCI 404.

In operation 514, wireless network 110 uses DCI 404 to schedule transmission of data 406 through the UL s-cell, which is s-cell 222 if a new s-cell was selected in operation 508 (but will instead be s-cell 211 if the UL s-cell is not changed). Scheduling transmission of data 406 comprises scheduling resource elements (REs) for the s-cell. UE 102 transmits data 406 to wireless network 110 using s-cell 222 in operation 516, and wireless network 110 receives data 406 from UE 102 through s-cell 222 in operation 518.

Decision operation 520 determines whether there has been a sufficient signal quality change for UE 102 (and/or network loading change) that interval 336 of repeating trigger events 334 should be changed. For example, a higher UL signal quality results in less frequent repeating trigger events, whereas a lower UL signal quality results in more frequent repeating trigger events. If so, then based on UL signal quality 330 changing, and/or network loading changing, s-cell selection logic 300 changes interval 336 of repeating trigger events 334 in operation 522.

Decision operation 524 determines whether another repeating trigger event has occurred for re-estimating s-cell throughputs for UE 102. If so, flowchart 500 returns to operation 506 to again estimate the throughput for UE 102 for each s-cell of plurality of s-cells 220.

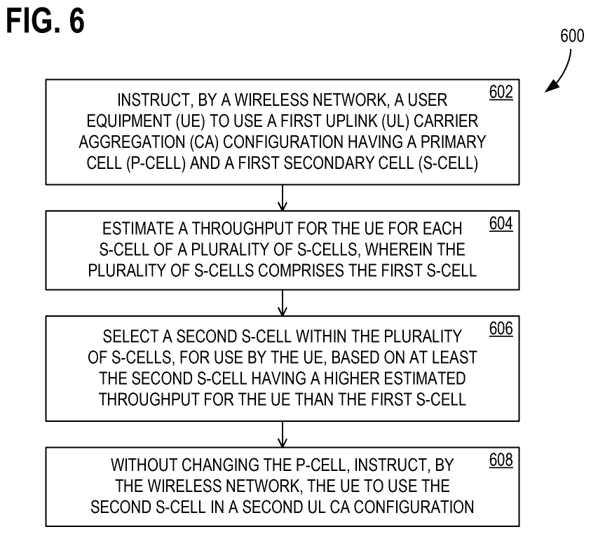

FIG. 6 illustrates a flowchart 600 of exemplary operations associated with architecture 100. In some examples, at least a portion of flowchart 600 may be performed using one or more computing devices 700 of FIG. 7. Flowchart 600 commences with operation 602, which includes instructing, by a wireless network, a UE to use a first UL CA configuration having a p-cell and a first s-cell.

Operation 604 includes estimating a throughput for the UE for each s-cell of a plurality of s-cells, wherein the plurality of s-cells comprises the first s-cell. Operation 606 includes selecting a second s-cell within the plurality of s-cells, for use by the UE, based on at least the second s-cell having a higher estimated throughput for the UE than the first s-cell. Operation 608 includes, without changing the p-cell, instructing, by the wireless network, the UE to use the second s-cell in a second UL CA configuration.

FIG. 7 illustrates a block diagram of computing device 700 that may be used as any component described herein that may require computational or storage capacity (e.g., a computer storage device). Computing device 700 has at least a processor 702 and a memory 704 that holds program code 710, data area 720, and other logic and storage 730. Memory 704 is any device allowing information, such as computer executable instructions and/or other data, to be stored and retrieved. For example, memory 704 may include one or more random access memory (RAM) modules, flash memory modules, hard disks, solid-state disks, persistent memory devices, and/or optical disks. Program code 710 comprises computer executable instructions and computer executable components including instructions used to perform operations described herein. Data area 720 holds data used to perform operations described herein. Memory 704 also includes other logic and storage 730 that performs or facilitates other functions disclosed herein or otherwise required of computing device 700. An input/output (I/O) component 740 facilitates receiving input from users and other devices and generating displays for users and outputs for other devices. A network interface 750 permits communication over external computer network 760 (e.g., computer network 124) with a remote node 770, which may represent another implementation of computing device 700. For example, a remote node 770 may represent another of the above-noted nodes within architecture 100.

### Additional Examples

An example system comprises: a processor; and a computer-readable medium storing instructions that are operative upon execution by the processor to: instruct, by a wireless network, a UE to use a first UL CA configuration having a p-cell and a first s-cell; estimate a throughput for the UE for each s-cell of a plurality of s-cells, wherein the plurality of s-cells comprises the first s-cell; select a second s-cell within the plurality of s-cells, for use by the UE, based on at least the second s-cell having a higher estimated throughput for the UE than the first s-cell; and without changing the p-cell, instruct, by the wireless network, the UE to use the second s-cell in a second UL CA configuration.

An example method of wireless communication comprises: instructing, by a wireless network, a UE to use a first UL CA configuration having a p-cell and a first s-cell; estimating a throughput for the UE for each s-cell of a plurality of s-cells, wherein the plurality of s-cells comprises the first s-cell; selecting a second s-cell within the plurality of s-cells, for use by the UE, based on at least the second s-cell having a higher estimated throughput for the UE than the first s-cell; and without changing the p-cell, instructing, by the wireless network, the UE to use the second s-cell in a second UL CA configuration.

One or more example computer storage devices has computer-executable instructions stored thereon, which, upon execution by a computer, cause the computer to perform operations comprising: instructing, by a wireless network, a UE to use a first UL CA configuration having a p-cell and a first s-cell; estimating a throughput for the UE for each s-cell of a plurality of s-cells, wherein the plurality of s-cells comprises the first s-cell; selecting a second s-cell within the plurality of s-cells, for use by the UE, based on at least the second s-cell having a higher estimated throughput for the UE than the first s-cell; and without changing the p-cell, instructing, by the wireless network, the UE to use the second s-cell in a second UL CA configuration.

Alternatively, or in addition to the other examples described herein, examples include any combination of the following:
the wireless network comprises a cellular network;
the UE comprises an eMBB, a cellphone, an FWA, an IoT device, an M2M communication device, or a PC with a cellular modem;
transmitting, by the UE, data to the wireless network using the second s-cell;
receiving, by the wireless network, the data from the UE through the second s-cell;
instructing the UE to use the second s-cell does not use an RRC message;
instructing the UE to use the second s-cell comprises using a DCI;
using the DCI, scheduling transmission of the data through the second s-cell;
estimating the throughput for the UE for each s-cell comprises, for each s-cell: determining an SINR for the s-cell; determining a PRB utilization for the s-cell; determining a TTI schedule for the UE for the s-cell; determining a carrier bandwidth of the s-cell; and/or determining a TDD and/or an FDD frame structure for the s-cell;
on each repeating trigger event, re-estimating the throughput for the UE for each s-cell of the plurality of s-cells;
based on a UL signal quality changing, changing an interval of the repeating trigger events;
instructing the UE to use a DL CA configuration with the p-cell and the plurality of s-cells;
instructing the UE to use the DL CA configuration with an RRC reconfiguration message;
instructing the UE to use the first UL CA configuration with an RRC reconfiguration message;
the second UL CA configuration has the p-cell and the second s-cell but does not have the first s-cell;
instructing the UE to use the second s-cell does not use an RRC reconfiguration message;
each RRC reconfiguration message comprises RRCConnectionReconfiguration;
scheduling transmission of the data comprises scheduling REs for the second s-cell;
a higher UL signal quality results in less frequent repeating trigger events;
a lower UL signal quality results in more frequent repeating trigger events;
the second s-cell has the highest estimated throughput for the UE of all s-cells in the plurality of s-cells; and
the estimated throughput for the UE is based on at least both radio signal quality and scheduling availability.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method comprising:
instructing, by a wireless network, a user equipment (UE) to use a first uplink (UL) carrier aggregation (CA) configuration having a primary cell (p-cell) and a first secondary cell (s-cell);
estimating a throughput for the UE for each s-cell of a plurality of s-cells, wherein the plurality of s-cells comprises the first s-cell;
selecting a second s-cell within the plurality of s-cells, for use by the UE, based on at least the second s-cell having a higher estimated throughput for the UE than the first s-cell; and
without changing the p-cell, instructing, by the wireless network, the UE to use the second s-cell in a second UL CA configuration.

2. The method of claim 1, further comprising:
transmitting, by the UE, data to the wireless network using the second s-cell; and
receiving, by the wireless network, the data from the UE through the second s-cell.

3. The method of claim 2, wherein instructing the UE to use the second s-cell does not use a radio resource control (RRC) message.

4. The method of claim 3, wherein instructing the UE to use the second s-cell comprises using downlink control information (DCI), and wherein the method further comprises:
using the DCI, scheduling transmission of the data through the second s-cell.

5. The method of claim 1, wherein estimating the throughput for the UE for each s-cell comprises, for each s-cell:
determining a signal-to-interference-plus-noise (SINR) for the s-cell;
determining a physical resource block (PRB) utilization for the s-cell;
determining a transmission time interval (TTI) schedule for the UE for the s-cell;
determining a carrier bandwidth of the s-cell; and/or
determining a time division duplexing (TDD) and/or frequency division duplexing frame structure for the s-cell.

6. The method of claim 1, further comprising:
on each repeating trigger event, re-estimating the throughput for the UE for each s-cell of the plurality of s-cells.

7. The method of claim 6, further comprising:
based on a UL signal quality changing, changing an interval of the repeating trigger events.

8. The method of claim 1, further comprising:
instructing the UE to use a downlink (DL) CA configuration with the p-cell and the plurality of s-cells.

9. A system comprising:
a processor; and
a computer-readable medium storing instructions that are operative upon execution by the processor to:
instruct, by a wireless network, a user equipment (UE) to use a first uplink (UL) carrier aggregation (CA) configuration having a primary cell (p-cell) and a first secondary cell (s-cell);
estimate a throughput for the UE for each s-cell of a plurality of s-cells, wherein the plurality of s-cells comprises the first s-cell;
select a second s-cell within the plurality of s-cells, for use by the UE, based on at least the second s-cell having a higher estimated throughput for the UE than the first s-cell; and
without changing the p-cell, instruct, by the wireless network, the UE to use the second s-cell in a second UL CA configuration.

10. The system of claim 9, wherein instructing the UE to use the second s-cell does not use a radio resource control (RRC) message.

11. The system of claim 10, wherein instructing the UE to use the second s-cell comprises using downlink control information (DCI), and wherein the operations are further operative to:
using the DCI, schedule transmission of data through the second s-cell.

12. The system of claim 9, wherein estimating the throughput for the UE for each s-cell comprises, for each s-cell:
determining a signal-to-interference-plus-noise (SINR) for the s-cell;
determining a physical resource block (PRB) utilization for the s-cell;
determining a transmission time interval (TTI) schedule for the UE for the s-cell;
determining a carrier bandwidth of the s-cell; and/or
determining a time division duplexing (TDD) and/or frequency division duplexing frame structure for the s-cell.

13. The system of claim 9, wherein the operations are further operative to:
on each repeating trigger event, re-estimate the throughput for the UE for each s-cell of the plurality of s-cells.

14. The system of claim 13, wherein the operations are further operative to:
based on a UL signal quality changing, change an interval of the repeating trigger events.

15. One or more computer storage devices having computer-executable instructions stored thereon, which, upon execution by a computer, cause the computer to perform operations comprising:
instructing, by a wireless network, a user equipment (UE) to use a first uplink (UL) carrier aggregation (CA) configuration having a primary cell (p-cell) and a first secondary cell (s-cell);
estimating a throughput for the UE for each s-cell of a plurality of s-cells, wherein the plurality of s-cells comprises the first s-cell;
selecting a second s-cell within the plurality of s-cells, for use by the UE, based on at least the second s-cell having a higher estimated throughput for the UE than the first s-cell; and
without changing the p-cell, instructing, by the wireless network, the UE to use the second s-cell in a second UL CA configuration.

16. The one or more computer storage devices of claim 15, wherein instructing the UE to use the second s-cell does not use a radio resource control (RRC) message.

17. The one or more computer storage devices of claim 16, wherein instructing the UE to use the second s-cell comprises using downlink control information (DCI), and wherein the operations further comprise:
using the DCI, scheduling transmission of data through the second s-cell.

18. The one or more computer storage devices of claim 15, wherein estimating the throughput for the UE for each s-cell comprises, for each s-cell:
determining a signal-to-interference-plus-noise (SINR) for the s-cell;
determining a physical resource block (PRB) utilization for the s-cell;
determining a transmission time interval (TTI) schedule for the UE for the s-cell;
determining a carrier bandwidth of the s-cell; and/or
determining a time division duplexing (TDD) and/or frequency division duplexing frame structure for the s-cell.

19. The one or more computer storage devices of claim 15, wherein the operations further comprise:
on each repeating trigger event, re-estimating the throughput for the UE for each s-cell of the plurality of s-cells.

20. The one or more computer storage devices of claim 19, wherein the operations further comprise:
based on a UL signal quality changing, changing an interval of the repeating trigger events.
